(19) United States
(12) Patent Application Publication
(10) Pub. No.: US 2015/0039480 A1
(43) Pub. Date: Feb. 5, 2015

(54) DETECTING AND FIXING PROBLEM VIDEO ACCOUNTS AND SUBSCRIPTIONS

(71) Applicant: Verizon Patent and Licensing Inc., Basking Ridge, NJ (US)

(72) Inventors: Zhiying Jin, Lexington, MA (US); Ruishuang Wang, Acton, MA (US)

(73) Assignee: Verizon Patent and Licensing Inc., Basking Ridge, NJ (US)

(21) Appl. No.: 13/954,458

(22) Filed: Jul. 30, 2013

(51) Int. Cl. G06Q 30/04

(52) U.S. Cl. CPC G06Q 30/04
USPC 705/34

(57) ABSTRACT

A computer device may include logic configured to manage an account creation process for customers, wherein the account creation process includes creating a DVD account in a DVD system, creating a digital account in a digital system, and creating a billing account in a billing system and manage a subscription generation process for the customers, wherein the subscription generation process includes associated a subscription with the DVD account, associating the subscription with the digital account, and associating the subscription with the billing account. The logic may be further configured to detect a broken account generated by the account creation process and fix the detected broken account in response to detecting the broken account; and detect a broken subscription generated by the subscription generation process and fix the detected broken subscription in response to detecting the broken subscription.

### BACKGROUND INFORMATION

Video media, such as movies or television shows, may be available in different formats. For example, some movies may be available for streaming while other movies may be available for DVD rental. Providers of video media may offer various packages that include video media available in different formats. A customer may need to create an account in order to consume video media through a provider. Management of customer accounts may require coordination between multiple systems.

### BRIEF DESCRIPTION OF THE DRAWINGS

FIG. 1 is a diagram illustrating an exemplary environment according to an implementation described herein;

FIG. 2 is a diagram illustrating exemplary components of a device that may be included in one or more components of FIG. 1;

FIG. 3 is a diagram illustrating exemplary functional components of the orchestration system of FIG. 1;

FIG. 4 is a diagram illustrating exemplary information that may be stored in a log database of the orchestration system of FIG. 1;

FIG. 5 is a diagram illustrating exemplary information that may be stored in an automatic call distribution metric cache of the orchestration system of FIG. 1;

FIG. 6 is a flowchart of a process for account creation according to an implementation described herein;

FIG. 7 is a flowchart for detecting broken accounts according to an implementation described herein;

FIG. 8 is a flowchart of a first process for recovering broken accounts according to an implementation described herein;

FIG. 9 is a flowchart of a second process for recovering broken accounts according to an implementation described herein;

FIG. 10 is a flowchart of a process for subscription generation according to an implementation described herein;

FIG. 11 is a flowchart for detecting broken subscriptions according to an implementation described herein;

FIG. 12 is a flowchart of a process for recovering broken subscription according to an implementation described herein;

FIG. 13 is a first exemplary signal flow according to an implementation described herein; and

FIG. 14 is a second exemplary signal flow according to an implementation described herein.

### DETAILED DESCRIPTION OF PREFERRED EMBODIMENTS

The following detailed description refers to the accompanying drawings. The same reference numbers in different drawings identify the same or similar elements.

Implementations described herein relate to detecting and fixing video accounts and/or subscriptions. A provider may offer a subscription service that includes streaming entitlements and video credits. For example, a customer may pay a particular price each billing period in return for entitlements to stream videos from a first catalog of videos and in return for receiving a particular number of DVD credits to rent videos from a second catalog of videos. Thus, the customer may stream videos to one or more devices (e.g., a set-top box, a personal computer, a mobile device, etc.) and the customer may visit a DVD kiosk and use the DVD credits to rent a DVD from the DVD kiosk.

In order for a customer to subscribe to the subscription service, the customer may need to create and account and to purchase the subscription. An account may be created for the customer with a DVD system in order for the customer to use the DVD credits. An account may be created for the customer with a digital system in order for the customer to stream videos. A billing account may be created for the customer with a billing system in order for the customer to be billed for the subscription. An orchestration system may manage an account creation process by instructing the DVD system to create a DVD system account for the customer. After a DVD system account is created, the orchestration system may instruct the digital system to create a digital system account for the customer. After a digital system account is created, the orchestration system may instruct the billing system to create a billing system account for the customer.

One or more of the accounts may not be created successfully, resulting in a broken account. For example, a DVD system account may be created for a customer without successfully creating a digital system account and/or a billing system account. A broken account may prevent a customer from being able to subscribe to the video streaming and DVD credits services. A broken account may result from an environmental error. For example, the orchestration system may, when instructing another system to create an account, encounter environmental errors, such as a network error, a firewall error, a storage space error, a memory error, a processor load error, and/or another kind of error. Some environment errors, such as an error caused due to a high network load, may be dealt with by waiting a particular length of time and resending an instruction to create the account. However, other types of environment error, such as a storage space error, for example, may require additional actions.

A broken account may also result from an account creation error. An account creation error may be the result of incompatible data structures between the various systems (e.g., different data fields); a faulty function, script file, or another type of coding error; a faulty interface (e.g., an application programming interface (API)); and/or another type of account creation error. If the orchestration system instructs a system to create an account using obtained customer information and receives an error, such as a “missing data field” error, the orchestration system cannot simply resend the instructions, as the same error will continue to be received.

Implementations described herein relate to detecting broken account and fixing detected broken accounts. A real time monitor in an orchestration system may monitor creation of accounts in a DVD system, in a digital system, and in a billing system. The real time monitor may detect account creation errors and may log detected account creation errors in an error log. The real time monitor may also compare the number of accounts created in the DVD system, the digital system, and the billing system over a particular period (e.g., 24 hours) and may determine whether the number of accounts created in the DVD system, the digital system, and the billing system over the particular time period match. Non-matching numbers may indicate one or more broken accounts.

The orchestration system may perform auto-recovery of broken accounts. For example, a particular environment error or a particular account creation error may be detected and corrected. When a customer logs in, a determination may be made whether the customer is associated with a broken account. If the error that caused the broken account has been corrected, the customer's accounts may be re-created automatically upon login.

Broken accounts may be fixed using a batch process. For example, an error that caused a broken account may be identified and a batch process may be generated to fix the cause of the broken account. For example, if the broken account was caused by a missing data field in one system that is required in another system, a script file may be generated to add the missing data field to the customer account records in the system where the data field is missing. Customers associated with broken accounts caused by the identified error may be identified and the batch process may be applied to the identified customers to fix the identified error.

Implementations described herein further relate to detecting and fixing broken subscriptions. After the customer has created an account, the customer may sign up for a subscription. A subscription charge may be generated for the customer in the billing system using payment information provided by the customer. After the subscription charge is made, entitlements may be created for the customer in the digital system to entitle the customer to stream videos. After the entitlements are created for the customer, DVD credits may be generated for the customer in the DVD system to enable the customer to rent DVDs from a DVD kiosk.

A broken subscription may result from an environment error and/or from a subscription generation error. A subscription generation error may be the result of incompatible data structures between the various systems; a faulty function, script file, or another type of coding error; a faulty interface; and/or another type of subscription generation error. The real time monitor may detect subscription generation errors and may log detected subscription generation errors in an error log. The real time monitor may also compare a DVD credits generation count, an entitlements generation count, and a subscription charges count during a particular time period and may determine whether the DVD credits generation count, the entitlements generation count, and the subscription charges count match. Non-matching counts may indicate one or more broken subscriptions.

A detected broken subscription may be fixed by instructing the digital system to remove entitlements associated with the subscription and instructing the digital system to recreate the entitlements associated with the subscription and by instructing the DVD system to remove the DVD credits associated with the subscription and instructing the DVD system to recreate the DVD credits associated with the subscription.

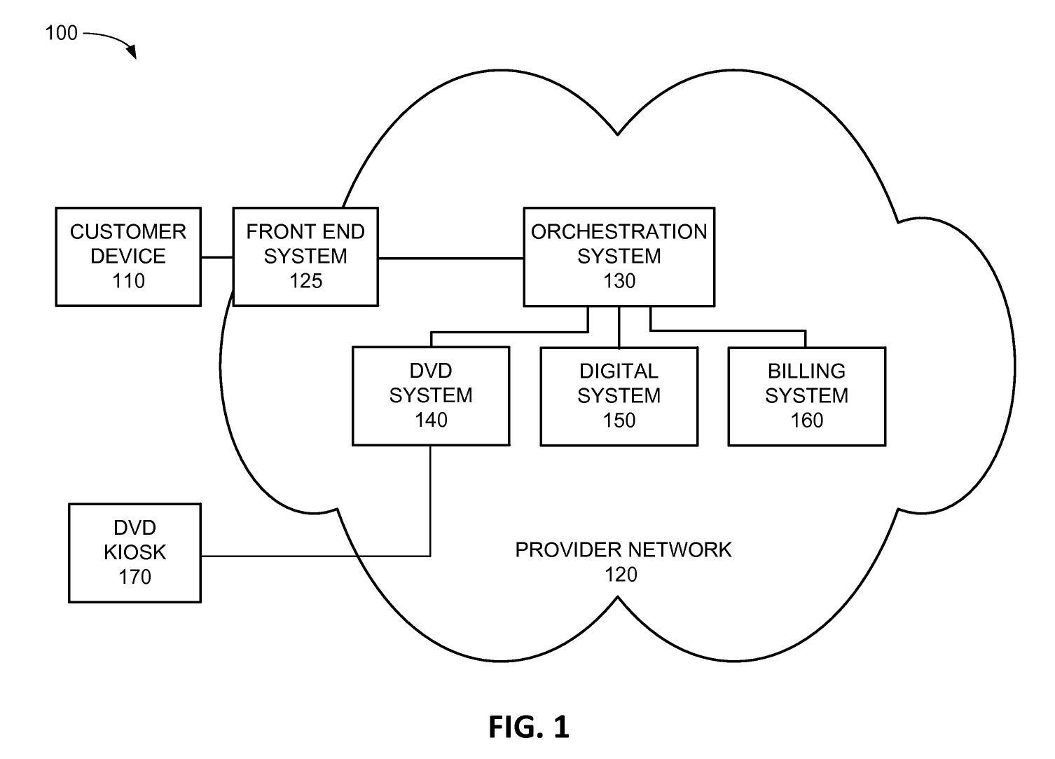

FIG. 1 is a diagram of an exemplary environment 100 in which the systems and/or methods described herein may be implemented. As shown in FIG. 1, environment 100 may include a customer device 110, a provider network 120, and a DVD kiosk 170.

Customer device 110 may include any device configured for communicating with a server device via a web browser application and/or a particular application received from a server device (e.g., a media playing application). Furthermore, customer device 110 may be configured to play streaming videos using a media application. For example, customer device 110 may include a portable communication device (e.g., a mobile phone, a smart phone, a phablet device, a global positioning system (GPS) device, and/or another type of wireless device); a personal computer or workstation; a server device; a laptop, tablet, or another type of portable computer; a set-top box; a gaming system; and/or any type of device with communication capability.

Provider network 120 may include one or more circuit-switched networks and/or packet-switched networks. For example, provider network 120 may include a local area network (LAN), a wide area network (WAN), a metropolitan area network (MAN), a Public Switched Telephone Network (PSTN), an ad hoc network, an intranet, the Internet, a fiber optic-based network, a wireless network, and/or a combination of these or other types of networks. Network 120 may include a front end system 125, an orchestration system 130, a DVD system 140, a digital system 150, and a billing system 160.

Front end system 125 may interface with a public network and may accessible by customer device 110. For example, front end system 125 may host one or more web pages that customer device 110 may access using a web browser. Front end system 125 may present a user interface that may enable a customer to request to create an account. After an account is created, the customer may request a subscription. Front end system 125 may collect information from customer device 110 about the customer and may the collected information to orchestration system 130. Furthermore, front end system 125 may enable a customer to stream videos to customer device 110.

Orchestration system 130 may manage an account creation process for customers. For example, orchestration system 130 may instruct DVD system 140 to create a DVD system account for a customer, may instruct digital system 150 to create a digital system account for the customer, and/or may instruct billing system 160 to create a billing system account for the customer. Furthermore, orchestration system 130 may detect broken accounts and may fix detected broken accounts. Moreover, orchestration system 130 may manage a subscription generation process for customers. For example, orchestration system 130 may instruct billing system 160 to generate a billing charge for a customer in response to receiving a request from front end system 125 to generate a subscription for the customer. After the subscription charge is generated, orchestration system 130 may instruct digital system 150 to create entitlements for the customer based on the subscription. The entitlements may enable the customer to stream videos (e.g., movies, TV shows, etc.) to customer device 110 and/or to other devices associated with the customer. Orchestration system 130 may further instruct DVD system 140 to generate DVD credits for the customer based on the subscription. The DVD credits may enable the customer to rent physical DVDs from DVD kiosk 170. Furthermore, orchestration system 130 may detect broken subscriptions and may fix the detected broken subscriptions.

DVD system 140 may manage DVD system accounts for customers. A DVD system account may store information about DVD credits assigned to the customer. DVD system 140 may provide information relating to DVD credits, associated with a customer, to DVD kiosk 170. Digital system 150 may manage digital system accounts for customers. A digital system account may store information about entitlements assigned to a customer. A customer may access an account via front end system 125 and may browse a catalog of videos available for streaming. When a customer requests to stream a video, front end system 125 may send the request to a content device that stores videos available for streaming (not shown in FIG. 1). The content device may check with digital system 150 to determine whether the customer is entitled to stream the requested video.

Billing system 160 may manage billing system accounts for customers. A billing system account may be used to generate a recurring charge for a subscription. For example, the billing system account may store payment information associated with the customer and may use the payment information to generate a charge for the customer for each billing cycle. Additionally or alternatively, the billing system account may be used to generate a bill for the customer and to deliver the bill to the customer.

DVD kiosk 170 may house physical DVDs. A customer may visit DVD kiosk 170 and may login using a username and password, using a credit card, and/or using another technique, and may use DVD credits to cause DVD kiosk 170 to dispense a physical DVD.

DVD kiosk 170 may communicate with DVD system 140 to retrieve information about DVD credits associated with a customer.

Although FIG. 1 shows exemplary components of environment 100, in other implementations, environment 100 may include fewer components, different components, differently arranged components, or additional components than depicted in FIG. 1. Additionally or alternatively, one or more components of environment 100 may perform functions described as being performed by one or more other components of environment 100.

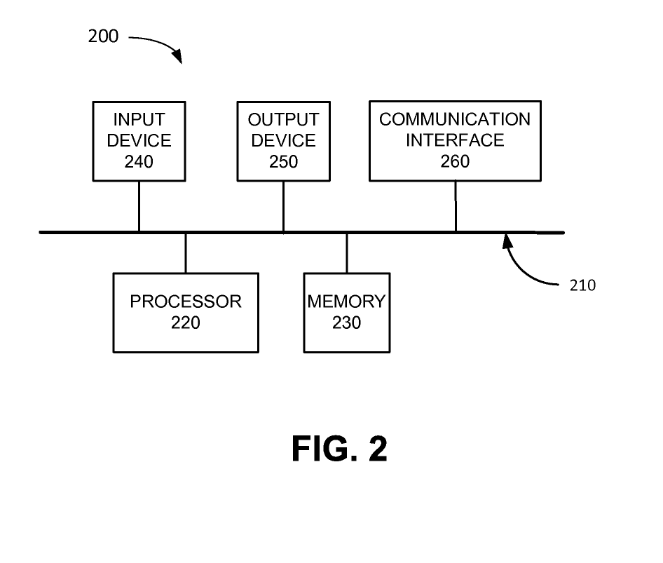

FIG. 2 is a diagram illustrating exemplary components of a device 200 according to an implementation described herein. Customer device 110, front end system 125, orchestration system 130, DVD system 140, digital system 150, billing system 160, and/or DVD kiosk 170 may each include one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some embodiments, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, device 200 may include a display, which may include a liquid-crystal display (LCD) for displaying content to the customer. In some embodiments, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to radio frequency (RF) signals and/or a receiver that converts RF signals to baseband signals. Communication interface 260 may be coupled to an antenna for transmitting and receiving RF signals.

Communication interface 260 may include a logical component that includes input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WiFi) card for wireless communications. Communication interface 260 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 200 may perform certain operations relating to generating accounts and/or subscriptions, detecting broken accounts and/or subscriptions, and/or fixing broken accounts and/or subscriptions. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally or alternatively, one or more components of device 200 may perform one or more tasks described as being performed by one or more other components of device 200.

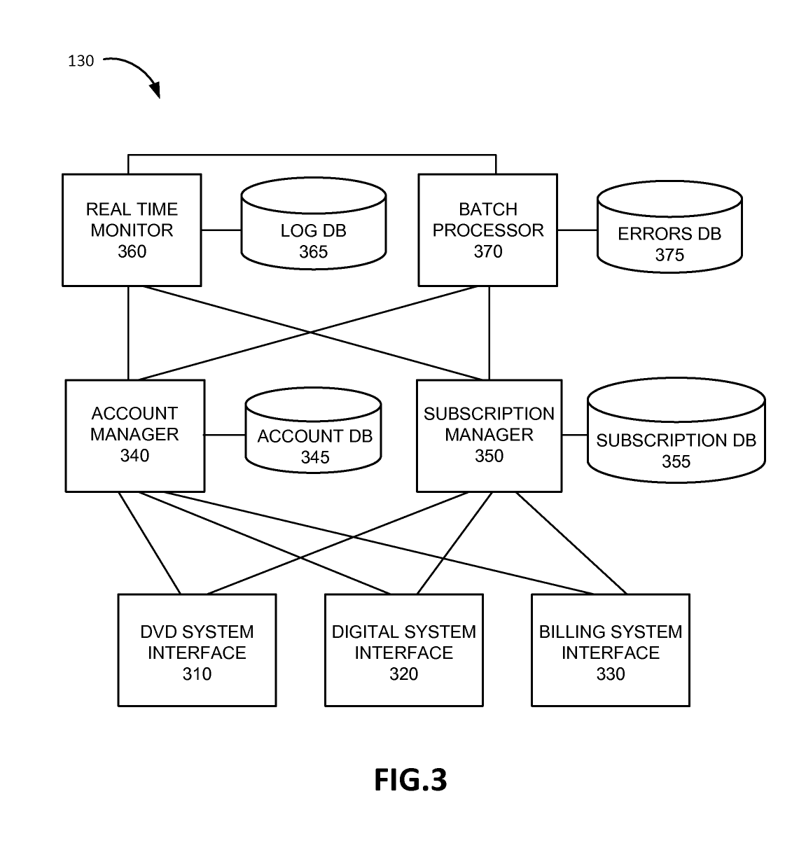

FIG. 3 is a diagram illustrating exemplary functional components of orchestration system 130. The functional components of orchestration system 130 may be implemented, for example, via processor 220 executing instructions from memory 230. Additionally or alternatively, some or all of the functional components of orchestration system 130 may be hard-wired. As shown in FIG. 3, orchestration system 130 may include a DVD system interface 310, a digital system interface 320, a billing system interface 330, an account manager 340, an account database (DB) 345, a subscription manager 350, a subscription DB 355, a real time monitor 360, a log DB 365, a batch processor 370, and an errors DB 375.

DVD system interface 310 may interface with DVD system 140 and may send instructions and/or inquiries to DVD system 140 and/or may receive responses from DVD system 140, such as whether or not an account was generated successfully and/or whether DVD credits were successfully issued for a customer. Digital system interface 320 may interface with digital system 150 and may send instructions and/or inquiries to digital system 150 and/or may receive responses from digital system 150, such as whether or not an account was generated successfully and/or whether entitlements were successfully issued for a customer. Billing system interface 330 may interface with billing system 160 and may send instructions and/or inquiries to billing system 160 and/or may receive response from billing system 160, such as whether or not an account was generated successfully and/or whether a subscription charge was successfully generated for a customer.

Account manager 340 may manage creation of accounts based on information received from front end system 125. For example, account manager 340 may instruct DVD system 140 to generate a DVD system account for a customer, may instruct digital system 150 to generate a digital system account for the customer, and/or may instruct billing system 160 to generate a billing system account for the customer. Account DB 345 may store account information associated with particular customers. For example, account DB 345 may include customer information received from front end system 125 for a particular customer, may include a DVD system account identifier for the particular customer, may include a digital system account identifier for the particular customer, and/or may include a billing system account identifier for the particular customer.

Subscription manager 350 may manage generation of subscriptions based on information received from front end system 125. For example, subscription manager 350 may instruct billing system 160 to generate a subscription charge for a customer, may instruct digital system 150 to generate entitlements for the customer, and may instruct the DVD system 140 to generate DVD credits for the customer. Subscription DB 355 may store subscription information associated with particular customers. For example, subscription DB 355 may store information identifying a type of subscription associated with a particular customer, information about a payment method associated with the subscription, information about entitlements associated with the subscription, information about DVD credits associated with the subscriptions, and/or other type of subscription information.

Real time monitor 360 may monitor creation of account in real time and may record errors detected during the creation of an account. For example, account manager 340 may receive an error message from DVD system 140, digital system 150, and/or billing system 160 in response sending an instruction to create account and real time monitor 360 may generate an error log based on the error message. As another example, account manager 340 may instruct DVD system 140, digital system 150, and/or billing system 160 to generate an account and may not receive an acknowledgement in response. In response, real time monitor 360 may generate an error log based on not receiving an acknowledgment to the sent instructions.

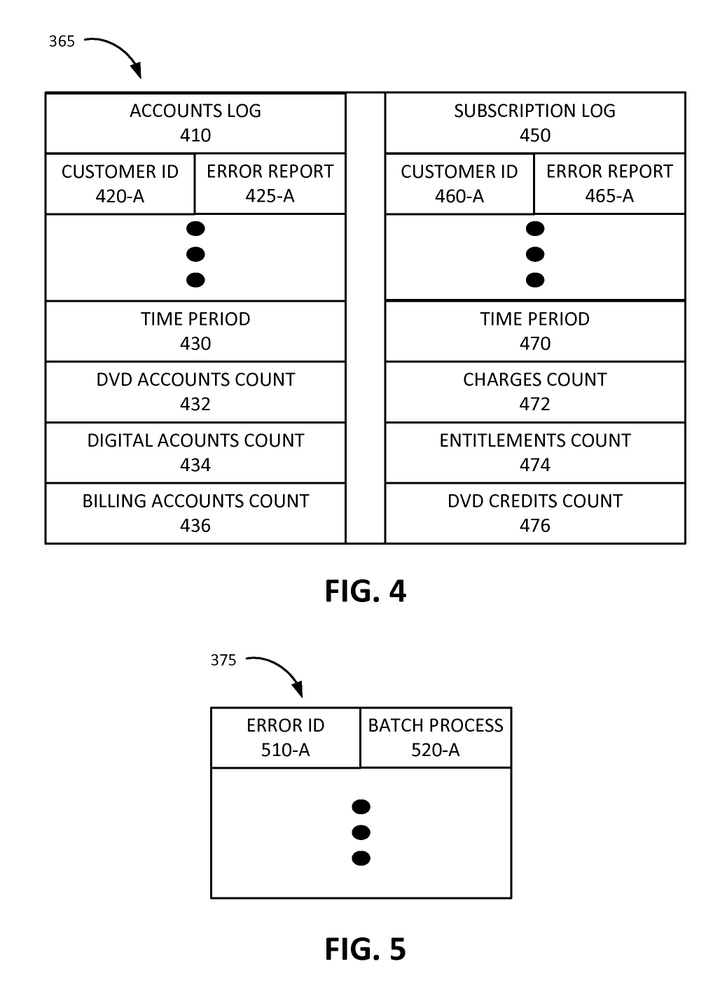

Furthermore, real time monitor 360 may monitor subscription generation in real time and may record errors detected during the generation of a subscription. For example, subscription manager 350 may receive an error message from DVD system 140, digital system 150, and/or billing system 160 in response sending an instruction relating to a subscription and real time monitor 360 may generate an error log based on the error message. As another example, subscription manager 350 may send an instruction relating to a subscription to DVD system 140, digital system 150, and/or billing system 160 and may not receive an acknowledgement in response. In response, real time monitor 360 may generate an error log based on not receiving an acknowledgment to the sent instructions. Log DB 365 may store log information generated during the creation of accounts. Exemplary information that may be stored in log DB 365 is described below with reference to FIG. 4.

Batch processor 370 may perform a batch process to correct an identified error that has been detected in connection with account creation or in connection with subscription generation. Batch processor 370 may identify customers that have been associated with the identified error and may apply a batch process, generated to correct the identified error, to the identified customers using errors DB 375. Errors DB 375 may store information associated with particular errors that have been detected in connection with account creation and/or subscription generation. Exemplary information that may be stored in errors DB 375 is described below with reference to FIG. 5.

Although FIG. 3 shows exemplary functional components of orchestration system 130, in other implementations, orchestration system 130 may include fewer functional components, different functional components, differently arranged functional components, or additional functional components than depicted in FIG. 3. Additionally or alternatively, one or more functional components of orchestration system 130 may perform functions described as being performed by one or more other functional components of orchestration system 130.

FIG. 4 is a diagram illustrating exemplary information that may be stored in log DB 365. As shown in FIG. 4, log DB 365 may include an accounts log 410 and a subscription log 450. Accounts log 410 may store a log of accounts created during a particular time period. Accounts log 410 may include one or more customer ID fields 420 and corresponding error reports 425, a time period field 430, a DVD accounts count field 432, a digital accounts count field 434, and a billing accounts count field 436.

Each customer ID field 420 may identify a particular customer that is associated with an account creation error. For example, customer ID field 420 may include a username associated with a customer, an account number associated with a customer, a telephone number associated with a customer, and/or another type of identifier associated with the customer. The corresponding error report field 425 may store information about one or more errors that were detected during an account creation process associated with the customer. For example, error report field 425 may identify that an error message was received from DVD system 140, digital system 150, and/or billing system 160. Additionally, error report field 425 may identify the type of error that was received and may include additional information associated with the error.

Time period field 430 may store information identifying a particular time period. DVD accounts count field 432 may store information identifying the number of DVD system accounts created during the particular time period. Digital accounts count field 434 may store information identifying the number of digital system accounts created during the particular time period. Billing accounts count field 436 may store information identifying the number of billing system accounts created during the particular time period.

Subscription log 450 may store a log of subscriptions created during a particular time period. Subscription log 450 may include one or more customer ID fields 460 and corresponding error reports 465, a time period field 470, a charges count field 472, an entitlements count field 474, and a DVD credits count field 476.

Each customer ID field 460 may identify a particular customer that is associated with subscription generation error. For example, customer ID field 460 may include a username associated with a customer, an account number associated with a customer, a telephone number associated with a customer, and/or another type of identifier associated with the customer. The corresponding error report field 465 may store information about one or more errors that were detected during a subscription generation process associated with the customer. For example, error report field 465 may identify that an error message was received from DVD system 140, digital system 150, and/or billing system 160. Additionally, error report field 465 may identify the type of error that was received and may include additional information associated with the error.

Time period field 470 may store information identifying a particular time period. Charges count field 472 may store information identifying the number of subscription charge events recorded during the particular time period. Entitlements count field 474 may store information identifying the number of entitlement generation events recorded during the particular time period. DVD credits count field 476 may store information identifying the number of DVD credits generation events recorded during the particular time period.

Although FIG. 4 shows exemplary components of log DB 365, in other implementations, log DB 365 may include fewer components, different components, differently arranged components, or additional components than depicted in FIG. 4.

FIG. 5 is a diagram illustrating exemplary information that may be stored in errors DB 375. As shown in FIG. 5, errors DB 375 may include one or more error ID fields 510 and corresponding batch process fields 520. Each error ID field 510 may identify a particular account generation error or a particular subscription generation error. The corresponding batch process field 520 may identify a batch process that has been generated to correct the particular account generation error or the particular subscription generation error. For example, batch process field 520 may include a script file, or may point to a script file, that has been generated to process customer accounts and/or subscriptions that have been identified as being associated with the particular account generation error or the particular subscription generation error.

Although FIG. 5 shows exemplary fields of errors DB 375, in other implementations, errors DB 375 may include fewer fields, different fields, differently arranged fields, or additional fields than depicted in FIG. 5.

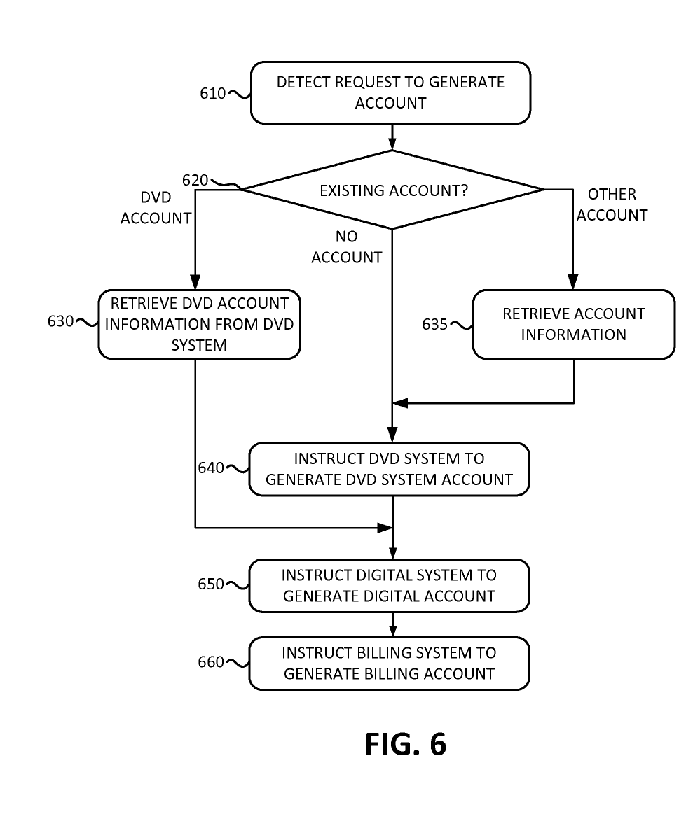

FIG. 6 is a flowchart of a process for account creation according to an implementation described herein. In one implementation, the process of FIG. 6 may be performed by orchestration system 130. In other implementations, some or all of the process of FIG. 6 may be performed by another device or a group of devices separate from and/or including orchestration system 130.

The process of FIG. 6 may include detecting a request to generate an account (block 610). For example, a customer may use customer device 110 to access a web page hosted by front end system and may request to sign up for a subscription that includes video streaming services along with DVD credits. In response, front end system 125 may request that the customer set up an account first. The customer may be directed to a web page to provide customer information and the customer information may be sent, along with a request to generate an account for the customer, to orchestration system 130.

A determination may be made as to whether there is an existing account for the customer (block 620). For example, front end system 125 may prompt the user to indicate whether the user has a DVD account associated with DVD kiosk 170. The user may provide identifying information (e.g., username, email address, account number, etc.) that may be used to retrieve an existing customer account from DVD system 140. As another example, the customer may have an account associated with provider network 120 (e.g., an Internet provider account, a wireless communication account, a television services account, etc.) and the customer's existing account may be retrieved to obtain the customer's information.

If account manager 340 determines that the customer has a DVD account (block 620—DVD ACCOUNT), DVD account information may be retrieved from DVD system 140 (block 630) and no DVD system account may need to be generated. Processing may continue to block 650. If account manager 340 determines that the customer has another type of account (block 620—OTHER ACCOUNT), information associated from the other account may be retrieved from an account management device associated with provider network 120 (not shown in FIG. 1) and used to generate a DVD account for the customer (block 635). Processing may continue to block 640. If account manager 340 determines that no account is associated with the customer (block 620—NO ACCOUNT), processing may continue to block 640.

Account manager 340 may instruct DVD system 140 to generate a DVD system account for the customer (block 640). Account manager 340 may provide customer information to DVD system 140. The customer information may be obtained by front end system 125 when the customer fills out one or more forms on a web page or otherwise provides the information to front end system 125. Alternatively, account manager 340 may have obtained the customer information from another account associated with the customer. DVD system 140 may send a report back to orchestration system 130, indicating whether or not the DVD system account has been successfully generated. If the DVD system account has not been successfully generated, account manager 340 may retry a particular number of times to instruct DVD system 140 to generate the account.

Account manager 340 may proceed to instruct digital system 150 to generate a digital system account (block 650). Account manager 340 may send the customer information to digital system 150 and may receive a report from digital system 150 indicating whether or not the digital system account has been successfully generated. If the digital system account has not been successfully generated, an error report may be generated and stored in accounts log 410.

Account manager 340 may proceed to instruct billing system 160 to generate a billing system account (block 660). Account manager 340 may send the customer information to billing system 160 and may receive a report from billing system 160 indicating whether or not the billing system account has been successfully generated. If the billing system account has not been successfully generated, an error report may be generated and stored in accounts log 410.

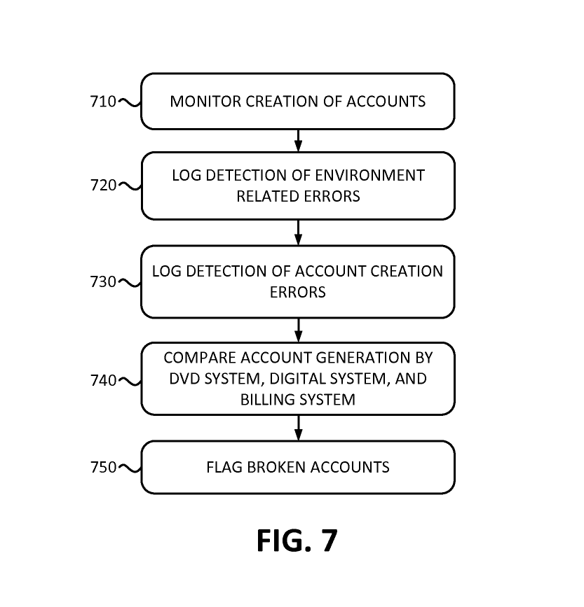

FIG. 7 is a flowchart for detecting broken accounts according to an implementation described herein. In one implementation, the process of FIG. 7 may be performed by orchestration system 130. In other implementations, some or all of the process of FIG. 7 may be performed by another device or a group of devices separate from and/or including orchestration system 130.

The process of FIG. 7 may include monitoring creation of accounts (block 710). For example, real time monitor 360 may monitor account creation performed by account manager 340 and may determine whether account manager 340 encountered any errors during the generation of one or more of the three accounts that need to be generated for each customer. Detection of environment related errors may be logged (block 720). For example, real time monitor 360 may detect environment errors during an account creation process. Real time monitor 360 may analyze an error message received from DVD system 140, digital system 150, or billing system 160, or may detect a lack of response from DVD system 140, digital system 150, or billing system 160 in response to a sent instruction, and may determine that an environment error has occurred in response. Real time monitor 360 may detect a network error, may detect a firewall error, may detect a storage space error, may detect a memory error, may detect a processor load error, and/or may detect another type of environment error.

Detection of account creation errors may be logged (block 730). For example, real time monitor 360 may detect account creation errors during an account creation process. Real time monitor 360 may analyze an error message received from DVD system 140, digital system 150, or billing system 160 and may determine that the error message corresponds to an account creation error. Real time monitor 360 may detect an error associated with an account data structure, may detect an error associated with an account creation function, may detect an error associated with an account creation interface, and/or may detect another type of account creation error.

Account generation by DVD system 140, digital system 150, and billing system 160 may be compared (block 740). For example, real time monitor 360 may compare the number of DVD system accounts, the number of digital system accounts, and the number of billing system accounts that were created during a particular time period (e.g., during the last 24 hours). If the number of DVD system accounts created, the number of digital system accounts created, and the number of billing system accounts created do not match, real time monitor 360 may determine that one or more broken accounts were created during the particular time period. Real time monitor 360 may analyze messages received from DVD system 140, digital system 150, and billing system 160 during the particular time period to identify the one or more broken accounts.

Broken accounts may be flagged (block 750). For example, when real time monitor 460 detects an error during an account creation process, real time monitor 460 may generate an error report and store the error report in accounts log 410 of log DB 365. Real time monitor 360 may instruct account manager 340 to flag a customer account in account DB 345 as a broken account if the customer account is associated with an error report in log DB 365.

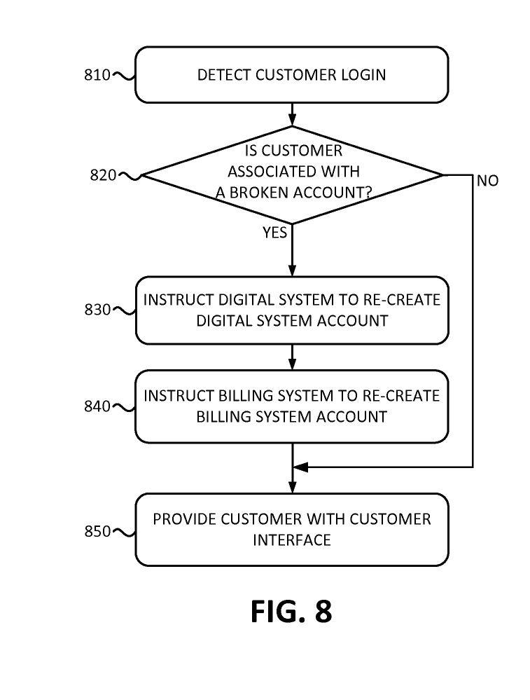

FIG. 8 is a flowchart of a first process for recovering broken accounts according to an implementation described herein. In one implementation, the process of FIG. 8 may be performed by orchestration system 130. In other implementations, some or all of the process of FIG. 8 may be performed by another device or a group of devices separate from and/or including orchestration system 130.

The process of FIG. 8 may include detecting a customer login (block 810). For example, a customer may log in (e.g., enter a username and a password) into a form provided by a web page hosted by front end system 125. Front end system 125 may send a request, along with the provided login information, to retrieve account information associated with the user. A determination may be made as to whether the customer is associated with a broken account (block 820). As an example, real time monitor 460 may access log DB 365 to determine whether the customer is associated with an error report. As another example, account manager 340 may access account DB 345 to determine whether the customer is associated with each of a DVD system account, a digital system account, and a billing system account.

If it is determined that the customer is not associated with a broken account (block 820—NO), processing may continue to block 850 to present the customer with a customer interface. If it is determined that the customer is associated with a broken account (block 820—YES), account manager 340 may instruct digital system 150 to re-create a digital system account for the customer (block 830). After the digital system account is re-created, account manager 340 may instruct billing system 160 to re-create a billing system account for the customer (block 840).

After the digital system account and the billing system account are re-created, the customer may be provided with a customer interface (block 850). For example, orchestration system 130 may provide information relating to the customer's accounts to front end system 125 and front end system 125 may generate a web page that provides account and/or subscription information to the user. Thus, broken accounts associated with a customer may be fixed in real time the first time that the customer logs into the customer's account.

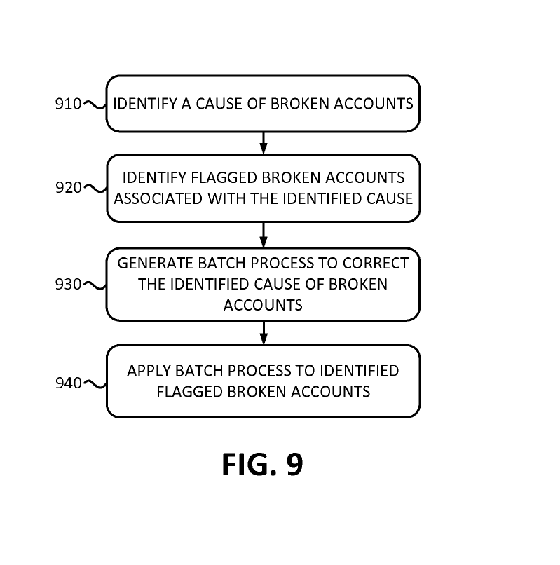

FIG. 9 is a flowchart of a second process for recovering broken accounts according to an implementation described herein. In one implementation, the process of FIG. 9 may be performed by orchestration system 130. In other implementations, some or all of the process of FIG. 9 may be performed by another device or a group of devices separate from and/or including orchestration system 130.

The process of FIG. 9 may include identifying a cause of broken accounts (block 910). Real time monitor 460 may determine that a particular error has been detected in a particular one of DVD system 140, digital system 150, or billing system 160. For example, real time monitor 460 may determine that a customer account field required by digital system 150 is not included in DVD system accounts stored in DVD system 140. Thus, when information from a DVD system account is used to generate a digital system account, an error is generated indicating a missing customer account field. As another example, real time monitor 460 may determine that attempts to create an account for a particular type of customer in DVD system 140 generate a particular function call error. As yet another example, real time monitor 460 may determine that an interface associated with billing system 160 generates an error when a particular type of payment method information is included in a request to generate a billing system account.

Flagged broken accounts, associated with the identified cause, may be identified (block 920). For example, real time monitor 460 may identify customers in accounts log 410 that are associated with an error report that includes the identified cause.

A batch process may be generated to correct the identified cause of broken accounts (block 930). In some implementations, an administrator may generate a batch process for a particular error. As an example, the administration may identify the error and may write a script to correct the error. For example, if a particular field is required for generating a digital system account and the required field is missing in DVD system accounts, the script file may add the required field based on information stored in accounts DB 345 and/or based on information obtained from front end system 125. In other implementations, a batch process may be generated automatically. For example, error DB 375 may include a database of errors and batch processor 370 may be configured to generate a batch processes for particular error types.

The batch process may be applied to the identified flagged broken accounts (block 940). For example, batch processor 370 may select a batch process associated with the error using errors DB 375 and may execute the selected batch process with respect to the identified customers. Thus, customers associated with broken accounts caused by the error will be processed and the broken accounts may be fixed using the batch process.

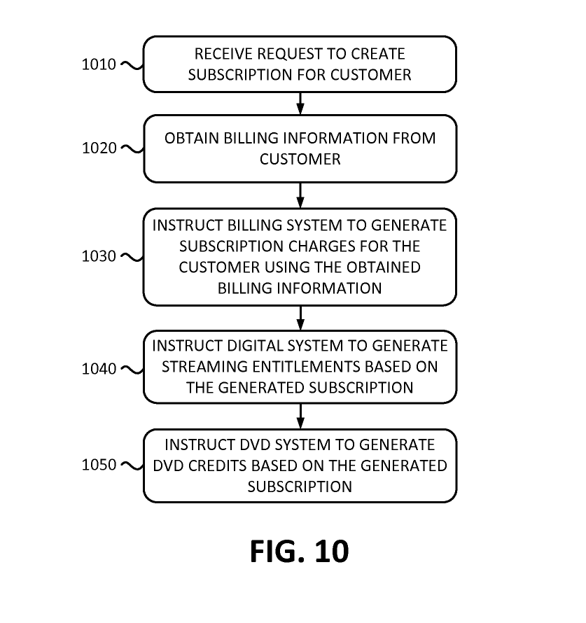

FIG. 10 is a flowchart of a process for subscription generation according to an implementation described herein. In one implementation, the process of FIG. 10 may be performed by orchestration system 130. In other implementations, some or all of the process of FIG. 10 may be performed by another device or a group of devices separate from and/or including orchestration system 130.

The process of FIG. 10 may include receiving a request to create a subscription for a customer (block 1010) and billing information may be obtained from the customer (block 1020). For example, the customer may access an account management web page on front end system 125 and may select a particular subscription option that enables the customer to stream videos and to receive DVD credits that can be redeemed at DVD kiosk 170. Front end system 125 may request billing information from the customer. As an example, the customer may provide credit card information for a credit card to which the customer wishes to charge the subscription. As another example, the customer may select to charge the subscription to another account that the customer has in association with provider network 120 (e.g., an Internet service account, a wireless communication account, a bundled services account, etc.). Front end system 125 may send a request to orchestration system 130 to generate the subscription for the customer. The request may include the obtained billing information.

Subscription manager 350 may instruct billing system 160 to generate subscription charges for the customer using the obtained billing information (block 1030). For example, subscription manager 350 may inform billing system 160 about the type of subscription the customer has selected and may provide payment information to billing system 160. Billing system 160 may generate a charge for the subscription using the received payment information using the customer's billing system account and may initiate a process to repeat the charge every billing cycle. If the charge was successfully processed (e.g., credit card payment was accepted by a bank issuing the credit card), billing system 160 may inform orchestration system 130 that the subscription charge was successfully generated.

After the subscription charge has been successfully generated, subscription manager 350 may instruct digital system 150 to generate streaming entitlements based on the generated subscription (block 1040). Digital system 150 may inform subscription manager 350 that the entitlements have been successfully generated. After the entitlements have been successfully generated, subscription manager 350 may instruct DVD system 140 to generate DVD credits based on the generated subscription (block 1050). DVD system 140 may inform subscription manager that the DVD credits have been successfully generated.

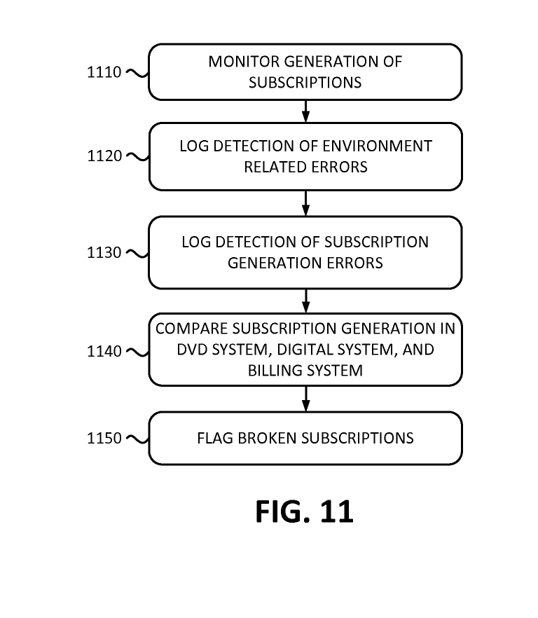

FIG. 11 is a flowchart for detecting broken subscriptions according to an implementation described herein. In one implementation, the process of FIG. 11 may be performed by orchestration system 130. In other implementations, some or all of the process of FIG. 11 may be performed by another device or a group of devices separate from and/or including orchestration system 130.

The process of FIG. 11 may include monitoring generation of subscriptions (block 1110). For example, real time monitor 360 may monitor subscription generation performed by subscription manager 350 and may determine whether subscription manager 350 encountered any errors while instructing billing system 160 to generate a subscription charge, while instructing digital system 150 to generate entitlements, or while instructing DVD system 140 to generate DVD credits.

Detection of environment related errors may be logged (block 1120). For example, real time monitor 360 may detect environment errors during the subscription generation process. Real time monitor 360 may analyze an error message received from DVD system 140, digital system 150, or billing system 160, or may detect a lack of response from DVD system 140, digital system 150, or billing system 160 in response to a sent instruction, and may determine that an environment error has occurred in response. Real time monitor 360 may detect a network error, may detect a firewall error, may detect a storage space error, may detect a memory error, may detect a processor load error, and/or may detect another type of environment error.

Detection of subscription generation errors may be logged (block 1130). For example, real time monitor 360 may detect subscription creation errors during the subscription generation process. Real time monitor 360 may analyze an error message received from DVD system 140, digital system 150, or billing system 160 and may determine that the error message corresponds to a subscription generation error. Real time monitor 360 may detect an error associated with a data structure, may detect an error associated with a function call, may detect an error associated with an interface, and/or may detect another type of subscription generation error.

Subscription generation by DVD system 140, digital system 150, and billing system 160 may be compared (block 1140). For example, real time monitor 360 may compare a DVD credits generation count, an entitlements generation count, and a subscription charges count during a particular time period, may determine that the DVD credits generation count, the entitlements generation count, and the subscription charges count do not match, and may determine that one or more broken subscriptions were created during the particular time period. Real time monitor 360 may analyze messages received from DVD system 140, digital system 150, and billing system 160 during the particular time period to identify the one or more broken subscriptions.

Broken subscriptions may be flagged (block 1150). For example, when real time monitor 460 detects an error during a subscription generation process for a customer, real time monitor 460 may generate an error report and store the error report in subscriptions log 450 of log DB 365. Real time monitor 360 may instruct subscription manager 350 to flag a customer subscription in subscription DB 355 as a broken subscription if the customer subscription is associated with an error report in log DB 365.

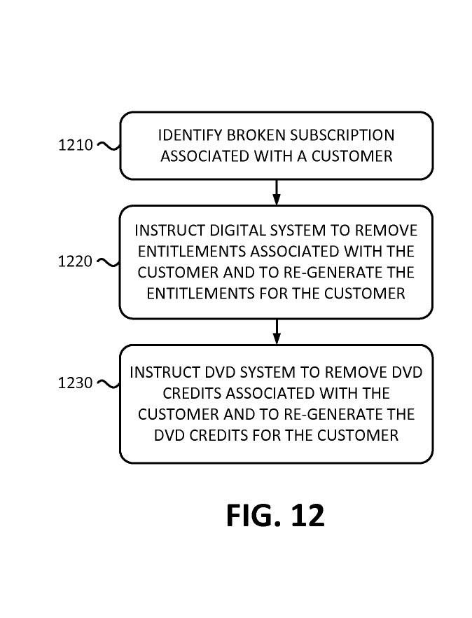

FIG. 12 is a flowchart of a process for recovering broken subscription according to an implementation described herein. In one implementation, the process of FIG. 12 may be performed by orchestration system 130. In other implementations, some or all of the process of FIG. 12 may be performed by another device or a group of devices separate from and/or including orchestration system 130.

The process of FIG. 12 may include identifying a broken subscription associated with a customer (block 1210). As an example, real time monitor 460 may access log DB 365 to determine whether the customer is associated with an error report in subscription log 450. If a problem is detected with either the entitlements or the DVD credits for a customer, both the entitlements and the DVD credits may need to be removed first, since additional requests to generate the entitlements or the DVD credits may result in errors if the entitlements or the DVD credits have been previously generated.

Thus, in response, batch processor 370 may instruct digital system 150 to remove entitlements associated with the customer and to re-generate entitlements for the customer (block 1220). Furthermore, batch processor 370 may instruct DVD system 140 to remove DVD credits associated with the customer and to re-generate DVD credits for the customer (block 1230). Removing and re-generating entitlements and DVD credits for the customer may fix the broken subscription for the customer.

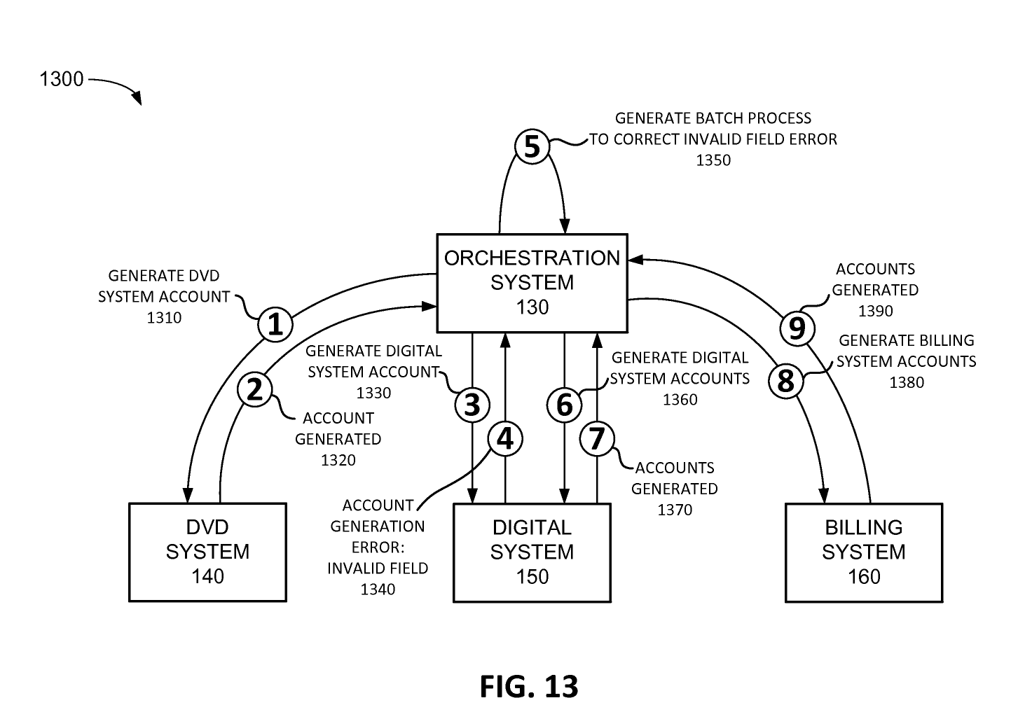

FIG. 13 is a first exemplary signal flow 1300 according to an implementation described herein. FIG. 13 illustrates an example of fixing a broken account. Signal flow 1300 may begin with orchestration system 130 instructing DVD system 140 to create a DVD system account for the customer (signal 1310). DVD system 140 ay respond with an acknowledgement message indicating that the DVD system account has been successfully created (signal 1320). Orchestration system 130 may then instruct digital system 150 to create a digital system account for the customer (signal 1330). Digital system 150 may respond by sending an account generation error to orchestration system 130 (signal 1340). The account generation error may indicate that an invalid field was included in the information sent to digital system 150 in the request to create the digital system account.

For example, DVD system 140 may include a field that indicates a preferred location of DVD kiosk 170 that the customer visits and the field may not be recognized by digital system 150. Orchestration system 130 may generate a batch file that removes the invalid field from the customer information before a request to create a digital system account is submitted to digital system 150 (signal 1350). The batch file may be applied to the broken account associated with the customer and an instruction may be re-submitted to digital system 150 to generate a digital system account for the customer (signal 1360). Digital system 150 may respond with an acknowledgement message indicating that the digital system account has been successfully created (signal 1370).

Orchestration system 130 may proceed to instruct billing system 160 to create a billing system account for the customer (signal 1380). Billing system 160 may respond with an acknowledgement message indicating that the DVD system account has been successfully created (signal 1390).

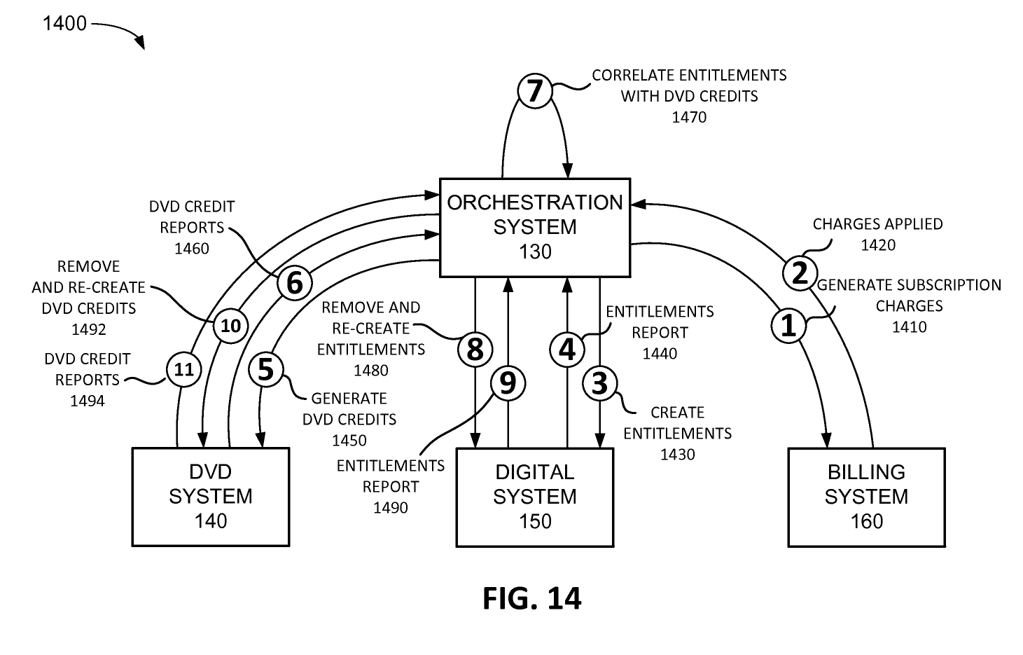

FIG. 14 is a second exemplary signal flow 1400 according to an implementation described herein. FIG. 14 illustrates an example of fixing a broken subscription. Signal flow 1400 may begin with orchestration system 130 instructing billing system 160 to generate subscription charges for customers that have requested a subscription (signal 1410). Billing system 160 may respond with acknowledgment messages indicating that charges have successfully been processed by billing system 160 (signal 1420).

After charges have been successfully processed, orchestration system 130 may instruct digital system 150 to generate entitlements for streaming videos for the customers (signal 1430). Digital system 150 may send an entitlement report back to orchestration system 130, indicating that entitlements have been generated for particular customers (signal 1440). Orchestration system 130 may proceed to instruct DVD system 140 to generate DVD credits for renting physical DVDs for customers (signal 1450). DVD system 140 may send a DVD credit report back to orchestration system 130, indicating that DVD credits have been generated for particular customers (signal 1450).

Orchestration system 130 may correlate entitlements with DVD credits (signal 1470). For example, orchestration system 130 may compare the number of entitlements generation events that have been acknowledged by digital system 150 with the number of DVD credits generation events that have been acknowledged by DVD system 140 over a particular time period, such as over the most recent 24 hour period. Orchestration system 130 may determine that the number of entitlements generation events does not match the number of DVD credits generation events. In some implementations, orchestration system 130 may attempt to identify particular customer subscriptions that are broken based on the identified mismatch. In other implementations, orchestration system 130 may select to reset all the subscriptions that were generated during the particular time period.

Orchestration system 130 may instruct digital system 150 to remove and re-create the entitlements for streaming videos for the customers (signal 1480). Digital system 150 may send an entitlement report back to orchestration system 130, indicating that entitlements have been generated for particular customers (signal 1490). Orchestration system 130 may proceed to instruct DVD system 140 to remove and re-create the DVD credits for renting physical DVDs for customers (signal 1492). DVD system 140 may send a DVD credit report back to orchestration system 130, indicating that DVD credits have been generated for particular customers (signal 1494).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while series of blocks have been described with respect to FIGS. 6-12, and an order of signal flows have been described with respect to FIGS. 13 and 14, the order of the blocks and/or signal flows may be modified in other implementations. Further, non-dependent blocks and/or signal flows may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code-it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method, performed by a computing device, the method comprising:
managing, by the computer device, an account creation process for customers, wherein the account creation process includes creating a DVD account in a DVD system, creating a digital account in a digital system, and creating a billing account in a billing system;
detecting, by the computer device, a broken account generated by the account creation process;
fixing, by the computer device, the detected broken account in response to detecting the broken account;
managing, by the computer device, a subscription generation process for the customers, wherein the subscription generation process includes associated a subscription with the DVD account, associating the subscription with the digital account, and associating the subscription with the billing account;
detecting, by the computer device, a broken subscription generated by the subscription generation process; and
fixing, by the computer device, the detected broken subscription in response to detecting the broken subscription.

2. The method of claim 1, wherein managing the account generation process includes:
determining that a customer is associated with an existing DVD system account;
retrieving customer information from the existing DVD system account;
generating the digital system account for the customer based on the retrieved customer information; and
generating the billing system account for the customer based on the retrieved customer information.

3. The method of claim 1, wherein detecting a broken account includes detecting that a particular digital system account or a particular billing system account, associated with a particular DVD system account, was not successfully created during the account creation process.

4. The method of claim 3, wherein detecting a broken account includes detecting environment errors during the account creation process, wherein detecting the environment errors include at least one of detecting a network error, detecting a firewall error, detecting a storage space error, detecting a memory error, or detecting a processor load error.

5. The method of claim 3, wherein detecting a broken account includes detecting account creation errors during the account creation process, wherein detecting the account creation errors include detecting an error associated with an account data structure, detecting an error associated with an account creation function, or detecting an error associated with an account creation interface.

6. The method of claim 3, wherein detecting a broken account includes:
comparing a number of DVD system accounts, a number of digital system accounts, and a number of billing system accounts generated during a particular time period;
determining that the number of DVD system accounts, the number of digital system accounts, and the number of billing system accounts generated during the particular time period do not match.

7. The method of claim 1, wherein fixing the detected broken account includes:
detecting a customer login;
determining that the customer is associated with the detected broken account;
instructing the digital system to re-create the digital system account for the customer in response to detecting that the customer is associated with the detected broken account; and
instructing the billing system to re-create the billing system account for the customer in response to detecting that the customer is associated with the detected broken account.

8. The method of claim 1, wherein fixing the detected broken account includes:
identifying a cause for the broken account;
identify customers associated with broken accounts associated with the identified cause;
generating a batch process to correct the identified cause; and
executing the batch process for the identified customers.

9. The method of claim 1, wherein managing the subscription generation process for the customers includes:
instructing the billing system to generate a subscription charge for a particular customer that has requested a subscription;
instructing the digital system to generate entitlements for the particular customer, wherein the entitlements enable the customer to stream videos; and
instructing the DVD system to generate DVD credits for the particular customer, wherein the DVD credits enable the customer to rent physical DVDs.

10. The method of claim 1, wherein detecting a broken subscription generated by the subscription generation process includes detecting environment errors during the subscription generation process, wherein detecting the environment errors include at least one of detecting a network error, detecting a firewall error, detecting a storage space error, detecting a memory error, or detecting a processor load error.

11. The method of claim 1, wherein detecting a broken subscription generated by the subscription generation process includes detecting subscription generation errors during the subscription generation process, wherein detecting the subscription generation errors include detecting an error associated with an subscription data structure, detecting an error associated with a subscription generation function, or detecting an error associated with a subscription generation interface.

12. The method of claim 1, wherein detecting a broken subscription generated by the subscription generation process includes:
comparing a DVD credits generation count, an entitlements generation count, and a subscription charges count during a particular time period; and
determining that the DVD credits generation count, the entitlements generation count, and the subscription charges count do not match.

13. The method of claim 1, wherein fixing the detected broken subscription includes:
instructing the digital system to remove entitlements associated with the subscription;
instructing the digital system to re-create the entitlements associated with the subscription;
instructing the DVD system to remove the DVD credits associated with the subscription; and
instructing the DVD system to re-create the DVD credits associated with the subscription.

14. A computer device comprising:
logic configured to:
manage an account creation process for customers, wherein the account creation process includes creating a DVD account in a DVD system, creating a digital account in a digital system, and creating a billing account in a billing system;
detect a broken account generated by the account creation process;
fix the detected broken account in response to detecting the broken acccount;
manage a subscription generation process for the customers, wherein the subscription generation process includes associated a subscription with the DVD account, associating the subscription with the digital account, and associating the subscription with the billing account;
detect a broken subscription generated by the subscription generation process; and
fix the detected broken subscription in response to detecting the broken subscription.

15. The computer device of claim 14, wherein, when detecting a broken account, the logic is further configured to at least one of:
detect environment errors during the account creation process, wherein detecting the environment errors include at least one of detecting a network error, detecting a firewall error, detecting a storage space error, detecting a memory error, or detecting a processor load error;
detect account creation errors during the account creation process, wherein detecting the account creation errors include detecting an error associated with an account data structure, detecting an error associated with an account creation function, or detecting an error associated with an account creation interface; or
determine that a number of DVD system accounts, a number of digital system accounts, and a number of billing system accounts generated during a particular time period do not match.

16. The computer device of claim 14, wherein, when fixing the broken account, the logic is further configured to:
detect a customer login;
determine that the customer is associated with the detected broken account;
instruct the digital system to re-create the digital system account for the customer in response to detecting that the customer is associated with the detected broken account; and
instruct the billing system to re-create the billing system account for the customer in response to detecting that the customer is associated with the detected broken account.

17. The computer device of claim 14, wherein, when fixing the broken account, the logic is further configured to:
identify a cause for the broken account;
identify customers associated with broken accounts associated with the identified cause;
generate a batch process to correct the identified cause; and
execute the batch process for the identified customers.

18. The computer device of claim 14, wherein, when detecting a broken subscription, the logic is further configured to at least one of:
detect environment errors during the subscription generation process, wherein detecting the environment errors include at least one of detecting a network error, detecting a firewall error, detecting a storage space error, detecting a memory error, or detecting a processor load error;
detect subscription generation errors during the subscription generation process, wherein detecting the subscription generation errors include detecting an error associated with a subscription data structure, detecting an error associated with a subscription generation function, or detecting an error associated with a subscription generation interface; or
determine that a DVD credits generation count, a entitlements generation count, and a subscription charges count during a particular time period do not match.

19. The computer device of claim 14, wherein, when fixing the broken subscription, the logic is further configured to:
instruct the digital system to remove entitlements associated with the subscription;
instruct the digital system to re-create the entitlements associated with the subscription;
instruct the DVD system to remove the DVD credits associated with the subscription; and
instruct the DVD system to re-create the DVD credits associated with the subscription.

20. A system comprising:
a DVD system configured to:
store DVD system accounts; and
manage DVD credits, associated with the stored DVD accounts, wherein the DVD credits enable customers to rent physical DVDs.;
a digital system configured to:
store digital system accounts; and
manage entitlements, associated with the stored digital system accounts, wherein the entitlements enable customers to stream videos;
a billing system configured to:
store billing system accounts; and
manage subscriptions, associated with the stored billing system accounts, wherein the subscriptions are associated with the DVD credits and the entitlements; and
an orchestration system configured to:
detect a broken account based on detecting that a particular one of the digital system accounts or a particular one of the billing system accounts, associated with a particular one of the DVD system accounts, was not successfully created during an account creation process;
fix the detected broken account in response to detecting the broken account;
detect a broken subscription based on detecting that a particular one of the entitlements or a particular one of the DVD credits, associated with a particular subscription, were not successfully generated; and
fix the detected broken subscription in response to detecting the broken subscription.
